(19) United States
(12) Patent Application Publication
(10) Pub. No.: US 2011/0110519 A1
(43) Pub. Date: May 12, 2011

(54) DATA TRANSMISSION DEVICE, DATA RECEPTION DEVICE, METHODS THEREOF, RECORDING MEDIUM, AND DATA COMMUNICATION SYSTEM THEREFOR

(76) Inventors: Tomoyasu Suzaki, Tokyo (JP); Yukiyasu Tsunoo, Tokyo (JP); Hiroyasu Kubo, Ishikawa (JP); Maki Shigeri, Ishikawa (JP); Teruo Saito, Ishikawa (JP); Takeshi Kawabata, Ishikawa (JP); Hiroki Nakashima, Ishikawa (JP)

(21) Appl. No.: 12/811,862

(22) PCT Filed: Jan. 9, 2009
(86) PCT No.: PCT/JP2009/000065

§ 371 Date: Jul. 7, 2010

(30) Foreign Application Priority Data
Jan. 9, 2008 (JP) 2008-001844

(51) Int. Cl. H04L 9/28

(52) U.S. Cl. 380/255

(57) ABSTRACT

A data transmission device (100) performs encryption processing on transmission data, performs encryption processing of a Feistel structure on the obtained first converted data, and performs processing in the relationship of an inverse function with the first encryption processing on the obtained second converted data. A first converting unit (105) divides transmission data into N sets (N being three or greater) of divided transmission data, performs operation processing on the divided transmission data to generate at least N sets of operation processing data, and combines the generated N sets of operation processing data to generate the first converted data. The first converting unit (105) selects a pair of first and second divided transmission data from the N sets of divided transmission data, performs a logical operation on the first divided transmission data and extended key data to generate a first operation result, performs an exclusive OR operation on the second divided transmission data and the first operation result to generate one set of operation processing data, performs a logical operation on the generated operation processing data and extended key data to generate a second operation result, and performs an exclusive OR operation on third divided transmission data selected from the N sets of divided transmission data and the second operation result to generate one set of the operation processing data.

### TECHNICAL FIELD

The present invention relates to a data transmission device, a data reception device, methods thereof, a computer readable recording medium that records a program for causing a computer to implement them, a data communication system that connects them, an encryption device that encrypts data, and a decryption device that decrypts data.

### BACKGROUND ART

Typical examples of common key block cryptosystems include DES (Data Encryption Standard). DES spread as a de facto standard since it was employed by FIPS in 1977.

FIG. 14 illustrates DES encryption processing. DES employs a structure called Feistel.

After the bit positions of a plain text are switched by initial permutation IP, a Feistel structure unit 900 stirs the plain text and key data, and the bits of the result are switched to form an encrypted text by final permutation IP⁻¹. The function F first expands 32-bit data to 48-bit data by expanding permutation E. An exclusive OR operation is then performed on the 48-bit data and a sub key K. The obtained data is divided into eight, and is converted by an S-box of 6-bit input and 4-bit output. The bits are then switched by permutation P, and the obtained data is output.

Currently, various kinds of suggestions for the above-described encryption device have been made (see Patent Documents 1 through 3, for example).
[Patent Document 1] Japanese Laid-Open Patent Publication No. 2002-082607
[Patent Document 2] Japanese Laid-Open Patent Publication No. 2002-091296
[Patent Document 3] Japanese Laid-Open Patent Publication No. 2006-072054

### DISCLOSURE OF THE INVENTION

However, the conventional arts disclosed in the above documents still have room for improvement in the following aspects.

FIG. 15 illustrates an example of differential cryptanalysis, which is a typical technique for attacking block cipher. Differential cryptanalysis is an attack utilizing the properties unique to an encryptor: where a certain difference (the exclusive OR between a pair of plain texts P1 and P2) ΔP (=ΔP_{L}|ΔP_{R}) is given to the encryptor, there is a high probability that a certain difference ΔD (ΔD_{L}, ΔD_{R}) appears in the intermediate data obtained after the X round (X ROUND) of the encryptor. Where the number of rounds, of the encryptor is (X+1), a pair of encrypted texts C1 and C2 are obtained by encrypting the pair of plain texts with the certain difference.

Here, when extended key data ekₓ used in the (X+1)th round is predicted, it is possible to go back one round from the pair of encrypted texts, and calculate the difference between the pair of data sets. If the difference is ΔD, the predicted extended key data ekₓ is determined to be correct. The above is the fundamental principle of differential cryptanalysis.

As described above, in algorithmic cryptanalysis of block cipher, the key data of the outside round is normally first determined. In DES cryptanalysis, the same attacking method can be applied.

As illustrated in FIG. 14, in DES, initial permutation IP and final permutation IP⁻¹ are performed outside the Feistel structure. However, the bits in plain texts or encrypted texts are simply permutated, and the values of plain texts or encrypted texts are simply changed. Therefore, there is no effect to increase the resistance to a attacking method such as a differential cryptanalysis.

Also, in some encryption, extended key data is inserted by performing an exclusive OR operation as the initial/final processing. With the above-described attacking method, those extended key data need to be predicted when the key data of the final round is predicted, and the amount of predictions becomes larger.

As illustrated in FIG. 16, however, key data that is inserted by an exclusive OR operation can be moved through an equivalent transformation, and the key data can be regarded as virtually nonexistent at the time of attacking. In some cases, the key data do not contribute to an increase in the amount of predictions.

Further, in cryptanalysis, there is an attack called the n round elimination attack, which is used in combination with differential cryptanalysis or the like. The n round elimination attack is an attack to increase the number of rounds in which deciphering can be performed, by predicting that the extended key data of one or more rounds from a plain text side, an encrypted text side, or both sides is shorter than the secret key length. It is necessary to take into account the n round elimination attack in conjunction with each attacking method.

To increase the resistance to the n round elimination attack, the amount of key data to be predicted is increased. Where the number of rounds is increased, the threat becomes smaller, but the processing speed becomes lower.

The present invention has been made in view of the above circumstances, and an object thereof is to provide a data transmission device that has higher resistance to each attacking method without degradation of implementation properties, a data reception device, methods thereof, a computer readable recording medium that records a program for causing a computer to implement them, a data communication system that connects them, an encryption device that encrypts data, and a decryption device that decrypts data.

According to one exemplary aspect of the invention, there is provided a data transmission device including a transmission data receiving unit that receives transmission data, a first converting unit that performs first encryption processing on the transmission data to generate first converted data, a second converting unit that performs encryption processing of a Feistel structure on the first converted data to generate second converted data, a third converting unit that performs second encryption processing that is in a relationship of an inverse function with the first encryption processing on the second converted data, to generate encrypted data, and a transmission unit that transmits the encrypted data, the first converting unit including a transmission data dividing unit that divides the transmission data into N sets (N being three or greater) of divided transmission data, an operation unit that performs operation processing on the divided transmission data to generate at least N sets of operation processing data, and a transmission data combining unit that combines the N sets of operation processing data generated by the operation unit, to generate the first converted data, the operation unit including a first processing unit that selects a pair of first and second divided transmission data from the N sets of divided transmission data, performs a logical operation on the first divided transmission data and extended key data to generate a first operation result, and performs an exclusive OR operation on the second divided transmission data and the first operation result to generate one set of the operation processing data, and a second processing unit that performs a logical operation on the operation processing data generated by the first processing unit and extended key data to generate a second operation result, and performs an exclusive OR operation on third divided transmission data selected from the N sets of divided transmission data and the second operation result to generate one set of the operation processing data.

According to another exemplary aspect of the invention, there is also provided a data reception device including a reception data receiving unit that receives reception data, a first converting unit that performs first decryption processing on the reception data to generate first converted data, a second converting unit that performs decryption processing of a Feistel structure on the first converted data to generate second converted data, and a third converting unit that performs second decryption processing that is in a relationship of an inverse function with the first decryption processing on the second converted data, to generate decrypted data, the first converting unit including a reception data dividing unit that divides the reception data into N sets (N being three or greater) of divided reception data, an operation unit that performs operation processing on the divided reception data to generate at least N sets of operation processing data, and a reception data combining unit that combines the N sets of operation processing data generated by the operation unit, to generate the first converted data, the operation unit including a first processing unit that selects a pair of first and second divided reception data from the N sets of divided reception data, performs a logical operation on the first divided reception data and extended key data to generate a first operation result, and performs an exclusive OR operation on the other set of divided reception data of the pair and the first operation result to generate one set of the operation processing data, and a second processing unit that performs a logical operation on the operation processing data generated by the first processing unit and extended key data to generate a second operation result, and performs an exclusive OR operation on third divided reception data selected from the N sets of divided reception data and the second operation result to generate one set of the operation processing data.

In another exemplary aspect of the invention, there is provided a data transmission method including acquiring transmission data, generating first converted data by performing first encryption processing on the transmission data, generating second converted data by performing encryption processing of a Feistel structure on the first converted data, generating encrypted data by performing second encryption processing that is in a relationship of an inverse function with the first encryption processing on the second converted data, and transmitting the encrypted data, the generating the first converted data including dividing the transmission data into N sets (N being three or greater) of divided transmission data, generating at least N sets of operation processing data by performing operation processing on the divided transmission data, and generating the first converted data by combining the N sets of operation processing data generated in the generating the N sets of operation processing data, the generating the N sets of operation processing data including performing first processing to select a pair of first and second divided transmission data from the N sets of divided transmission data, generate a first operation result by performing a logical operation on the first divided transmission data and extended key data, and generate one set of the operation processing data by performing an exclusive OR operation on the second divided transmission data and the first operation result, and performing second processing to generate a second operation result by performing a logical operation on the operation processing data generated in the performing the first processing and extended key data, and generate one set of the operation processing data by performing an exclusive OR operation on third divided transmission data selected from the N sets of divided transmission data and the second operation result.

According to another exemplary aspect of the invention, there is also provided a computer readable recording medium recording a program for causing a computer to perform a transmission data receiving process to receive transmission data, a first converting process to generate first converted data by performing first encryption processing on the transmission data, a second converting process to generate second converted data by performing encryption processing of a Feistel structure on the first converted data, a third converting process to generate encrypted data by performing second encryption processing that is in a relationship of an inverse function with the first encryption processing on the second converted data, and a transmitting process to transmit the encrypted data, the first converting process including a transmission data dividing process to divide the transmission data into N sets (N being three or greater) of divided transmission data, an operating process to generate at least N sets of operation processing data from the divided transmission data, and a transmission data combining process to generate the first converted data by combining the N sets of operation processing data generated through the operation processing, the operating process including a first process to select a pair of first and second divided transmission data from the N sets of divided transmission data, generate a first operation result by performing a logical operation on the first divided transmission data and extended key data, and generate one set of the operation processing data by performing an exclusive OR operation on the second divided transmission data and the first operation result, and a second process to generate a second operation result by performing a logical operation on the operation processing data generated through the first process and extended key data, and generate one set of the operation processing data by performing an exclusive OR operation on third divided transmission data selected from the N sets of divided transmission data and the second operation result.

According to another exemplary aspect of the invention, there is also provided a data reception method including acquiring reception data, generating first converted data by performing first decryption processing on the reception data, generating second converted data by performing decryption processing of a Feistel structure on the first converted data, and generating decrypted data by performing second decryption processing that is in a relationship of an inverse function with the first decryption processing on the second converted data, the generating the first converted data including dividing the reception data into N sets (N being three or greater) of divided reception data, generating at least N sets of operation processing data by performing operation processing on the divided reception data, and generating the first converted data by combining the N sets of operation processing data generated from the operation processing data, the generating the N sets of operation processing data including performing first processing to select a pair of first and second divided reception data from the N sets of divided reception data, generate a first operation result by performing a logical operation on the first divided reception data and extended key data, and generate one set of the operation processing data by performing an exclusive OR operation on the other set of divided reception data of the pair and the first operation result, and performing second processing to generate a second operation result by performing a logical operation on the operation processing data generated in the performing the first processing and extended key data, and generate one set of the operation processing data by performing an exclusive OR operation on third divided reception data selected from the N sets of divided reception data and the second operation result.

According to another exemplary aspect of the invention, there is also provided a computer readable recording medium recording a program for causing a computer to perform a reception data receiving process to receive reception data, a first converting process to generate first converted data by performing first decryption processing on the reception data, a second converting process to generate second converted data by performing decryption processing of a Feistel structure on the first converted data, and a third converting process to generate decrypted data by performing second decryption processing that is in a relationship of an inverse function with the first decryption processing on the second converted data, the first converting process including a reception data dividing process to divide the reception data into N sets (N being three or greater) of divided reception data, an operating process to generate at least N sets of operation processing data from the divided reception data, and a reception data combining process to generate the first converted data by combining the N sets of operation processing data generated through the operating process, the operating process including a first process to select a pair of first and second divided reception data from the N sets of divided reception data, generate a first operation result by performing a logical operation on the first divided reception data and extended key data, and generate one set of the operation processing data by performing an exclusive OR operation on the other set of divided reception data of the pair and the first operation result, and a second process to generate a second operation result by performing a logical operation on the operation processing data generated through the first process and extended key data, and generate one set of the operation processing data by performing an exclusive OR operation on third divided reception data selected from the N sets of divided reception data and the second operation result.

According to another exemplary aspect of the invention, there is also provided a data communication system that connects the data transmission device and the data reception device via a network.

According to another exemplary aspect of the invention, there is also provided an encryption device including a data receiving unit that receives a plain text, a memory that stores extended key data, a first converting unit that performs first encryption processing on the plain text to generate first converted data, a second converting unit that performs encryption processing of a Feistel structure on the first converted data to generate second converted data, and a third converting unit that performs second encryption processing that is in a relationship of an inverse function with the first encryption processing on the second converted data, to generate encrypted data, the first converting unit including a data dividing unit that divides the plain text into N sets (N being three or greater) of divided data, an operation unit that performs operation processing on the divided data to generate at least N sets of operation processing data, and a data combining unit that combines the N sets of operation processing data generated by the operation unit, to generate the first converted data, the operation unit including a first processing unit that selects a pair of first and second divided data from the N sets of divided data, performs a logical operation on the first divided data and extended key data read from the memory to generate a first operation result, and performs an exclusive OR operation on the second divided data and the first operation result to generate one set of the operation processing data, and a second processing unit that performs a logical operation on the operation processing data generated by the first processing unit and extended key data read from the memory to generate a second operation result, and performs an exclusive OR operation on third divided data selected from the N sets of divided data and the second operation result to generate one set of the operation processing data.

According to another exemplary aspect of the invention, there is also provided a decryption device including a data receiving unit that receives encrypted data, a memory that stores extended key data, a first converting unit that performs first decryption processing on the encrypted data to generate first converted data, a second converting unit that performs decryption processing of a Feistel structure on the first converted data to generate second converted data, and a third converting unit that performs second decryption processing that is in a relationship of an inverse function with the first decryption processing on the second converted data, to generate a plain text, the first converting unit including a reception data dividing unit that divides the reception data into N sets (N being three or greater) of divided reception data, an operation unit that performs operation processing on the divided reception data to generate at least N sets of operation processing data, and a reception data combining unit that combines the N sets of operation processing data generated by the operation unit, to generate the first converted data, the operation unit including a first processing unit that selects a pair of first and second divided reception data from the N sets of divided reception data, performs a logical operation on the first divided reception data and extended key data read from the memory to generate a first operation result, and performs an exclusive OR operation on the other set of divided reception data of the pair and the first operation result to generate one set of the operation processing data, and a second processing unit that performs a logical operation on the operation processing data generated by the first processing unit and extended key data read from the memory to generate a second operation result, and performs an exclusive OR operation on third divided reception data selected from the N sets of divided reception data and the second operation result to generate one set of the operation processing data.

The respective components of the present invention may be formed to realize the functions thereof. For example, the components of the present invention can be realized as special-purpose hardware that has a predetermined function, a data transmission device and a data reception device with predetermined functions provided by a computer program, predetermined functions realized by a data transmission device and a data reception device according to a computer program, or arbitrary combinations of those functions.

The respective components of the present invention may not necessarily be independent of one another. Two or more components may be formed as a single member, a single component may be formed with two or more members, a single component may be part of another component, part of a single component may overlap with part of another component, or the like.

Although the processes are sequentially disclosed in the descriptions of the data transmission method and the data reception method of the present invention, the sequences disclosed do not limit the sequences in which the processes are carried out. Therefore, when the data transmission method and the data reception method of the present invention are implemented, the sequences of the processes may be changed, without adversely affecting the contents thereof.

Further, the processes in the data transmission method and the data reception method of the present invention may not necessarily be performed in different timings from one another. Therefore, a process may occur during execution of another process, part or all of the execution timing of a process may overlap with the execution timing of another process, or the like.

The data transmission device and the data reception device according to the present invention may be realized as hardware formed with general-purpose devices such as a CPU (Central Processing Unit), a ROM (Read Only Memory), a RAM (Random Access Memory), and an I/F (Interface) unit, a special-purpose logic circuit designed to perform predetermined data processing, a combination of the hardware and the logic circuit, or the like.

According to the present invention, high-speed processing can be performed, while resistance to the n round elimination attack is made higher. Also, according to the present invention, the functions of encryption and decryption are shared by one device so that an increase in size at the time of installment can be restrained.

### BRIEF DESCRIPTION OF THE DRAWINGS

The above mentioned objects and other objects, and features and advantages of the present invention will become more apparent from the following detailed description of exemplary embodiments when read in conjunction with the accompanying drawings.

FIG. 1 is a block diagram schematically illustrating a data communication system of an exemplary embodiment.

FIG. 2 is a block diagram schematically illustrating the structure of a first converting unit of the exemplary embodiment.

FIG. 3 is a block diagram schematically illustrating the structure of a key data generating unit of the exemplary embodiment.

FIG. 4 is a drawing for explaining the structure of an encryption device that is equivalent to an encryption unit of the exemplary embodiment.

FIG. 5 is a drawing for explaining encryption processing of a generalized Feistel structure.

FIG. 6 is a drawing for schematically illustrating the structures of the encryption device and a key schedule device of the exemplary embodiment.

FIG. 7 is a drawing for explaining an example of first encryption processing to be performed by a first converting unit (an initial processing means) of the exemplary embodiment.

FIG. 8 is a drawing for explaining an example of the first encryption processing to be performed by the first converting unit (the initial processing means) of the exemplary embodiment.

FIG. 9 is a drawing for explaining an example of second encryption processing to be performed by a second converting unit (a final processing means) of the exemplary embodiment.

FIG. 10 is a drawing for explaining an example of the second encryption processing to be performed by the second converting unit (the final processing means) of the exemplary embodiment.

FIG. 11 is a drawing for explaining encryption processing of a Feistel structure to be performed by a round function means of the exemplary embodiment.

FIG. 12 is a drawing for explaining the processing of the key schedule device of the exemplary embodiment.

FIG. 13 is a drawing for explaining processing to be performed by a key data generating means of the exemplary embodiment.

FIG. 14 is a drawing for explaining DES encryption processing.

FIG. 15 illustrates an example of a method for attacking block cipher.

FIG. 16 is a drawing for explaining relevant encryption processing.

### EXEMPLARY EMBODIMENTS

The following is a description of exemplary embodiments of the present invention, with reference to the accompanying drawings.

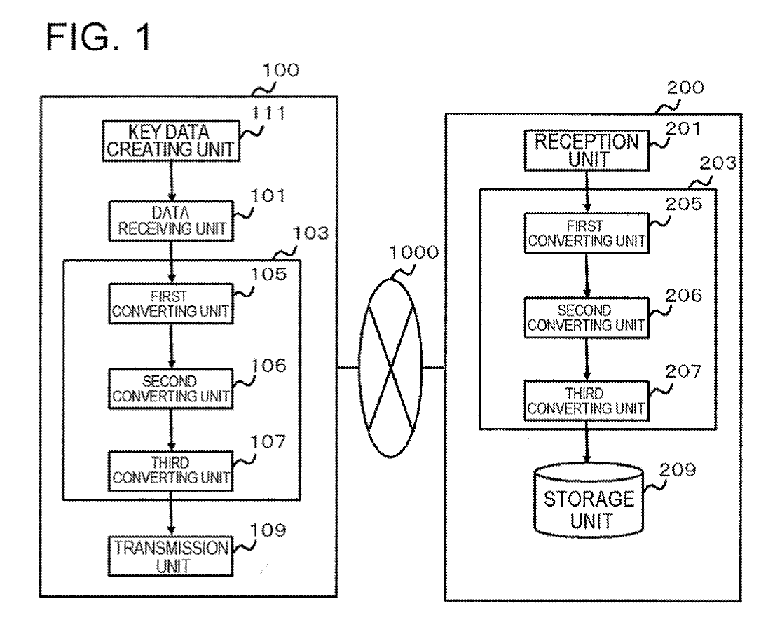

FIG. 1 is a block diagram schematically illustrating a data communication system of this exemplary embodiment. The data communication system of this exemplary embodiment connects a data transmission device 100 and a data reception device 200 via a network 1000.

The data transmission device 100 includes a data receiving unit 101 that receives transmission data and extended key data, an encryption unit 103 that encrypts transmission data to generate encrypted data, and a transmission unit 109 that transmits the encrypted data.

The encryption unit 103 includes a first converting unit 105 that performs first encryption processing on transmission data to generate first converted data, a second converting unit 106 that performs encryption processing of a Feistel structure on the first converted data to generate second converted data, and a third converting unit 107 that performs second encryption processing on the second converted data to generate encrypted data, the second encryption processing being in the relationship of an inverse function with the first encryption processing.

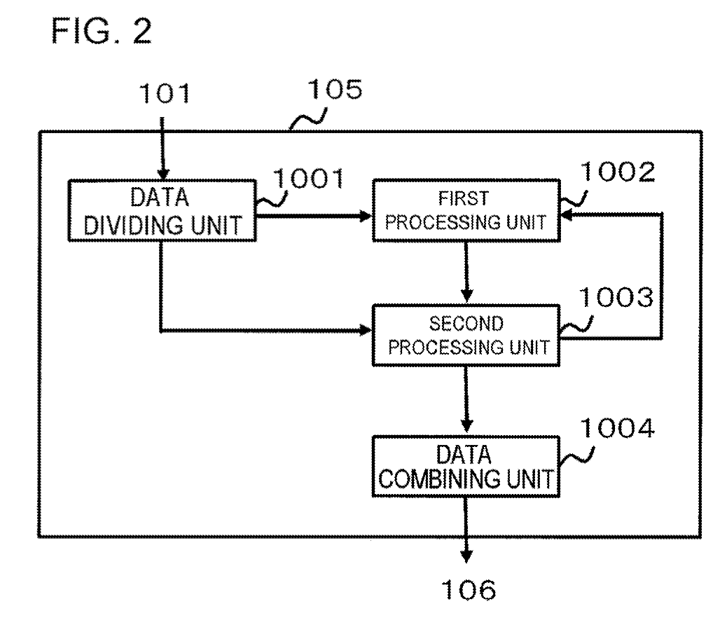

FIG. 2 is a block diagram schematically illustrating the structure of the first converting unit 105. The first converting unit 105 includes a data dividing unit 1001 that divides the transmission data into N (N being three or greater) sets of divided transmission data, an operation unit (a first processing unit 1002 and a second processing unit 1003) that performs operation processing on the divided transmission data to generate at least N sets of operation processing data, and a data combining unit 1004 that combines the N sets of operation processing data generated by the operation unit and generates the first converted data. The operation unit includes the first processing unit 1002 (the first processing means) that selects a pair of first and second divided transmission data from the N sets of divided transmission data, performs a logical operation that is not an exclusive OR operation on the first divided transmission data and extended key data to generate a first operation result, and performs an exclusive OR operation on the second divided transmission data and the first operation result to generate one set of operation processing data, and the second processing unit 1003 (the second processing means) that performs a logical operation that is not an exclusive OR operation on the operation processing data generated by the first processing unit 1002 and extended key data to generate a second operation result, and also performs an exclusive OR operation on third divided transmission data selected from the N sets of divided transmission data and the second operation result to generate one set of operation processing data.

In a case where N is four, for example, the first encryption processing may be exemplified by the processing illustrated in FIG. 7. First, the first processing unit 1002 selects a pair of divided transmission data 701 and 702 from four sets of divided transmission data divided by the data dividing unit 1001, and performs a logical AND operation 30 on the divided transmission data 701 and extended key data ek0. The first processing unit 1002 performs an exclusive OR operation on the generated operation result and the divided transmission data 702 to generate operation processing data 705, and transmits the operation processing data 705 to the second processing unit 1003. The second processing unit 1003 selects the divided transmission data 703 from the four sets of divided transmission data divided by the data dividing unit 1001, and also performs a logical OR operation 31 on the operation processing data 705 and extended key data ek2. The second processing unit 1003 then performs an exclusive OR operation on the generated operation result and the divided transmission data 703 to generate operation processing data 706.

The first processing unit 1002 also selects a pair of divided transmission data 703 and 704 from the four sets of divided transmission data divided by the data dividing unit 1001, and performs a logical OR operation 31 on the divided transmission data 703 and extended key data ek1. The first processing unit 1002 then performs an exclusive OR operation on the generated operation result and the divided transmission data 704 to generate operation processing data 707, and transmits the operation processing data 707 to the second processing unit 1003. The second processing unit 1003 selects the divided transmission data 701 from the four sets of divided transmission data divided by the data dividing unit 1001, and performs the logical OR operation 31 on the operation processing data 707 and extended key data ek3. The second processing unit 1003 performs an exclusive OR operation on the generated operation result and the divided transmission data 701 to generate operation processing data 708.

Using input data that are the generated operation processing data, the above operation unit may perform second operation processing on N sets of input data to generate N sets of second operation processing data.

In a case where N is four, for example, the four sets of operation processing data 705, 706, 707, and 708 that are temporarily stored in the second processing unit 1003 are used as input data, as exemplified in FIG. 7. The first processing unit 1002 selects a pair of input data 705 and 708, and performs the logical OR operation 31 on the input data 708 and extended key data ek4. The first processing unit 1002 performs an exclusive OR operation on the generated operation result and the input data 705 to generate operation processing data 709, and transmits the operation processing data 709 to the second processing unit 1003 (the fourth processing means). The second processing unit 1003 performs a logical AND operation on the operation processing data 709 generated by the first processing unit 1002 and extended key data ek6. The second processing unit 1003 then performs an exclusive OR operation on the generated operation result and the input data 706 to generate operation processing data 710.

The first processing unit 1002 also selects a pair of input data 706 and 707, and performs the logical AND operation 30 on the input data 706 and extended key data ek5. The first processing unit 1002 then performs an exclusive OR operation on the generated operation result and the input data 707 to generate operation processing data 711 (the fifth processing means). The second processing unit 1003 performs the logical OR operation 31 on the operation processing data 711 generated by the first processing unit 1002 and extended key data ek7. The second processing unit 1003 performs an exclusive OR operation on the generated operation result and the input data 708 to generate operation processing data 712.

Then, the data combining unit 1004 receives the four sets of operation processing data 709, 710, 711, and 712 from the second processing unit 1003, and combines them to form first converted data.

Using input data that are the N sets of second operation processing data generated through the above second operation processing, the first processing unit 1002 and the second processing unit 1003 may repetitively perform the second operation processing on the N sets of input data.

The first processing 1002 and the second processing unit 1003 may also perform a logical operation that is not an exclusive OR operation on the generated operation processing data and extended key data to generate a third operation result, and perform an exclusive OR operation on third divided transmission data selected from the N sets of divided transmission data and the third operation result to generate one set of operation processing data (the third processing means).

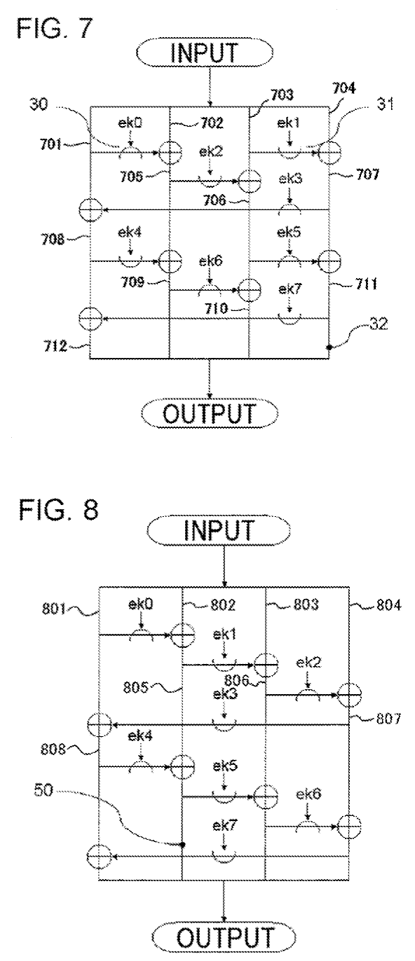

Referring now to FIG. 8, an example of the third processing means is described. The second processing unit 1003 performs a logical operation on the generated operation processing data 806 and the extended key data ek2. The second processing unit 1003 then performs an exclusive OR operation on the generated operation result and divided transmission data 804 to generate operation processing data 807.

Using the operation processing data generated by the third processing means, the second processing unit 1002 may repetitively perform the same processing as that of the third processing means. For example, in the example illustrated in FIG. 8, the second processing unit 1003 performs a logical OR operation on the generated operation processing data 807 and the extended key data ek3. The second processing unit 1003 then performs an exclusive OR operation on the generated operation result and divided transmission data 801 to generate operation processing data 808.

In the example illustrated in FIG. 8, the generated operation processing data 805, 806, 807, and 808 are used as input data, and a series of operation processing is performed on the four sets of input data 805, 806, 807, and 808 to generate four sets of operation processing data. The operation processing using the input data 805, 806, 807, and 808 as illustrated is the same as the processing except the divided transmission data replaced with input data in the first, second, and third processing means.

The data dividing unit 1001 receives transmission data and extended key data from the data receiving unit 101. The data receiving unit 101 may read extended key data stored in a memory (not illustrated). The divided transmission data as well as the extended key data are transmitted to the first processing unit 1002 and the second processing unit 1003. Here, the transmission data is divided into three or more sets of divided transmission data, and pairs are generated from the divided transmission data. The generated pairs may be transmitted to the first processing unit 1002.

The first processing unit 1002 and the second processing unit 1003 perform encryption processing of a generalized Feistel type as the first encryption processing. However, the first processing unit 1002 uses a logical OR operation or a logical AND operation, but not an exclusive OR operation, to stir the input data and the extended key data in the encryption processing of the generalized Feistel type.

Also, the first processing unit 1002 and the second processing unit 1003 perform logical operations other than exclusive OR operations in the operation processing using extended keys. The logical operations may be a logical OR operation and a logical AND operation, for example. Alternatively, the first processing unit 1002 and the second processing unit 1003 may perform arithmetic adding.

As described above, the first processing unit 1002 and the second processing unit 1003 can repetitively perform operation processing on each pair, with the input data being the N operation results generated through operation processing. The number of repetitions may be one, or may be two or more.

With this structure, the first converting unit 105 performs the first encryption processing. The data combining unit 1004 then transmits the generated first converted data to the second converting unit 106.

The second converting unit 106 performs encryption processing of a Feistel structure.

The third converting unit 107 performs encryption processing of a generalized Feistel type. However, the third converting unit 107 uses a logical OR or logical AND, but not an exclusive OR, to stir input data and extended key data in the encryption processing of the generalized Feistel type. Here, the data processing by the third converting unit 107 is in a relationship of an inverse function with the data processing by the first converting unit 105, so that the second converting unit 106 can maintain its responsiveness.

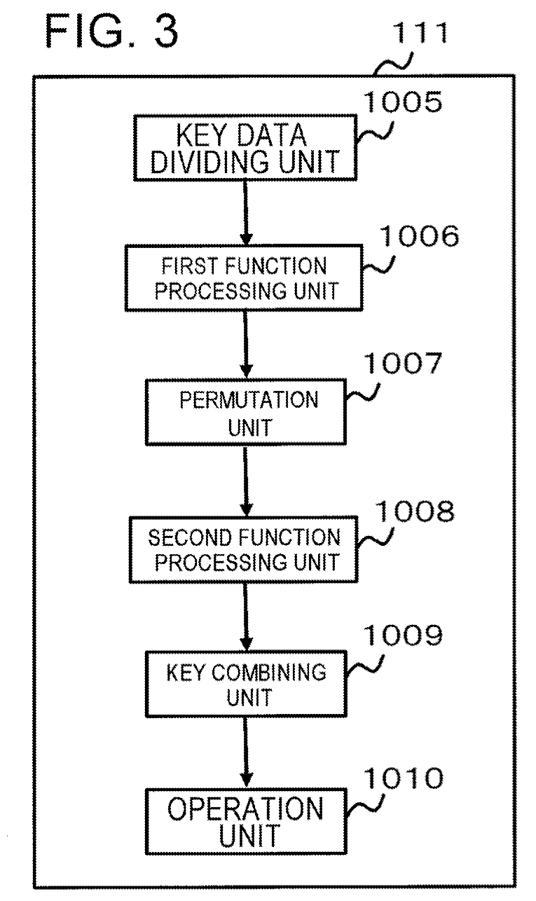

The data transmission device 100 further includes a key data generating unit 111 that generates extended key data from secret key data via intermediate key data. FIG. 3 is a block diagram schematically illustrating the structure of the key data generating unit 111. The key data generating unit 111 includes a key data dividing unit 1005 that divides secret key data into M (M being two or greater), and obtains M-divided key data, a first function processing unit 1006 that performs round function (F-function) processing on each set of the M-divided key data, a permutation unit 1007 that divides the M-divided key data subjected to the F-function processing, combines part of one set of the M-divided key data with part of another set of the M-divided key data, and permutates the M-divided data to output M sets of permutated data, a second function processing unit 1008 that performs F-function processing on each set of the output permutated data, a key combining unit 1009 that combines the permutated data subjected to the F-function processing, to generate intermediate key data, and an operation unit 1010. The operation unit 1010 receives the intermediate key data from the key combining unit 1009, and calculates extended key data. Specifically, the extended key data can be generated by performing an exclusive OR operation on the intermediate key data and a predetermined number, or performing an exclusive OR operation on the secret key data, the intermediate key data, and a predetermined number.

Referring back to FIG. 1, the data reception device 200 includes a reception unit 201 that receives reception data received via the network 1000 and extended key data, a decryption unit 203 that decrypts the reception data and obtains decrypted data, and a storage unit 209 that stores the extended key data and the decrypted data.

The decryption unit 203 includes a first converting unit 205 that performs first decryption processing on the reception data to generate first converted data, a second converting unit 206 that performs decryption processing of a Feistel structure on the first converted data to generate second converted data, and a third converting unit 207 that performs second decryption processing that is in a relationship of an inverse function with the first decryption processing on the second converted data, to generate decrypted data.

The first converting unit 205 has the same structure as the first converting unit 105 illustrated in FIG. 2. In the first converting unit 205, however, the data dividing unit 1001 divides the reception data into N sets (N being three or greater) of divided reception data. The first processing unit 1002 and the second processing unit 1003 perform operation processing on the divided reception data to generate at least N sets of operation processing data. The data combining unit 1004 combines the N sets of operation processing data generated by the second processing unit 1003 to generate the first converted data.

Using input data that are the N sets of operation processing data generated through the operation processing, the first processing unit 1002 and the second processing unit 1003 of the first converting unit 205 may also repetitively perform the operation processing. The number of repetitions may be one, or may be two or more.

With this structure, the first converting unit 205 performs the first decryption processing. The data combining unit 1004 transmits the generated first converted data to the second converting unit 206.

The respective components of the above-described data transmission device 100 and the data reception device 200 are realized by using various kinds of hardware as needed. However, the respective components are realized by the data transmission device 100 and the data reception device 200 functioning according to an installed computer program.

Such a computer program is stored as software for causing a CPU or the like to perform processing operations such as the transmission data receiving process for receiving transmission data, the first converting process for generating the first converted data by performing the first encryption processing on the transmission data, the second converting process for generating the second converted data by performing the encryption processing of a Feistel structure on the first converted data, the third converting process for generating encrypted data by performing the second encryption processing that is in the relationship of an inverse function with the first encryption processing, and a transmitting process for transmitting the encrypted data. Such a computer program is stored in an information storage medium such as a RAM.

Also, such a computer program is stored as software for causing a CPU or the like to perform processing operations such as the data receiving process for receiving reception data, the first converting process for generating the first converted data by performing the first decryption processing on the reception data, a second converting process for performing decryption processing of a Feistel structure on the first converted data, and a third converting process for generating decrypted data by performing the second decryption processing that is in the relationship of an inverse function with the first decryption processing on the second converted data. Such a computer program is stored in an information storage medium such as a RAM.

In this exemplary embodiment, the first operation processing performed by the first converting unit 105 is in the relationship of an inverse function with the second operation processing performed by the third converting unit 107. Accordingly, the encryption unit 103 can also function as the decryption unit 203. Thus, the data transmission device 100 can also function as the data reception device 200.

In the following, the encryption unit 103 of the data communication system of this exemplary embodiment is described in greater detail.

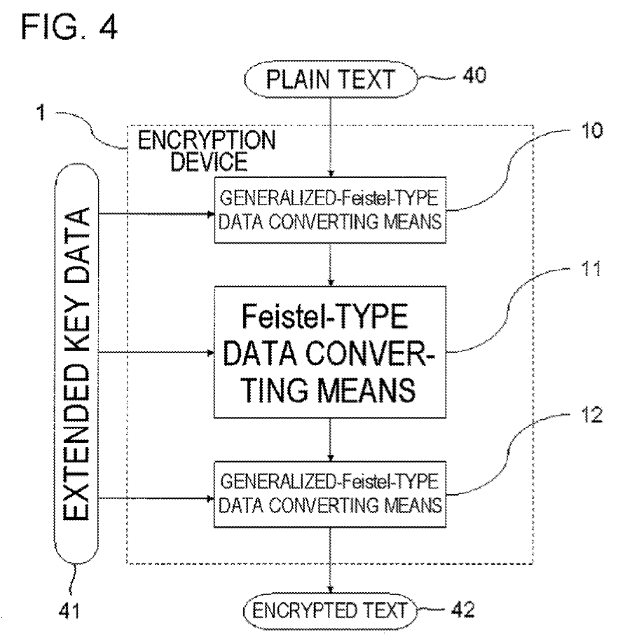

FIG. 4 is a drawing for explaining the structure of an encryption device 1 that is equivalent to the encryption unit 103. This encryption device 1 includes a data receiving means that receives a plain text 40, a memory (not illustrated) that stores extended key data 41, a generalized-Feistel-type data converting means (a first converting means) 10 that performs first encryption processing on the plain text 40 to generate first converted data, a Feistel-type data converting means (a second converting means) 11 that performs encryption processing of a Feistel structure on the first converted data to generate second converted data, and a generalized-Feistel-type data converting unit (a third converting unit) 12 that performs second encryption processing that is in a relationship of an inverse function with the first encryption processing on the second converted data, to generate an encrypted text 42. The generalized-Feistel-type data converting means 10 includes a data dividing means that divides the plain text 40 into N sets (N being three or greater) of divided data, an operation means that performs operation processing on the divided data to generate at least N sets of operation processing data, and a data combining means that combines the N sets of operation processing data generated by the operation means to generate the first converted data. The operation means includes a first processing means that selects a pair of first and second divided data from the N sets of divided data, performs a logical operation on the first divided data and the extended key data read from the memory to generate a first operation result, and performs an exclusive OR operation on the second divided data and the first operation result to generate one set of operation processing data, and a second processing means that performs a logical operation on the operation processing data generated by the first processing means and the extended key data read from the memory to generate a second operation result, and performs an exclusive OR operation on third divided data selected from the N sets of divided data and the second operation result to generate one set of the operation processing data.

This encryption device 1 also functions as the following decryption device. The decryption device includes a data receiving means that receives the encrypted text 42, a memory that stores the extended key data 41, a generalized-Feistel-type data converting means (a first converting means) 12 that performs first decryption processing on the encrypted text 42 to generate first converted data, a Feistel-type data converting means (a second converting means) 11 that performs decryption processing of a Feistel structure on the first converted data to generate second converted data, and a generalized-Feistel-type data converting unit (a third converting unit) 10 that performs second decryption processing that is in a relationship of an inverse function with the first decryption processing on the second converted data, to generate the plain text 40. The generalized-Feistel-type data converting means 12 includes a reception data dividing means that divides reception data into N sets (N being three or greater) of divided reception data, an operation means that performs operation processing on the divided reception data to generate at least N sets of operation processing data, and a reception data combining means that combines the N sets of operation processing data generated by the operation means to generate the first converted data. The operation means includes a first processing means that selects a pair of first and second divided reception data from the N sets of divided reception data, performs a logical operation on the first divided reception data and the extended key data read from the memory to generate a first operation result, and performs an exclusive OR operation on the other divided reception data of the pair and the first operation result to generate one set of operation processing data, and a second processing means that performs a logical operation on the operation processing data generated by the first processing means and the extended key data read from the memory to generate a second operation result, and performs an exclusive OR operation on third divided reception data selected from the N sets of divided reception data and the second operation result to generate one set of the operation processing data.

To be more specific, the encryption device 1 is a device that receives data and extended key data, and encrypts and decrypts the data. The encryption device 1 includes the first generalized-Feistel-type data converting means 10, the Feistel-type data converting means 11, and the second generalized-Feistel-type data converting means 12. The generalized-Feistel-type data converting means 10 is equivalent to the first converting unit 105, and the Feistel-type data converting means 11 is equivalent to the second converting unit 106, and the generalized-Feistel-type data converting means 12 is equivalent to the third converting unit 107.

The Feistel-type data converting means 11 includes a means of dividing input data into two, a means of applying extended key data to one set of the divided data and performing a nonlinear operation, a means of performing an exclusive OR operation on the data subjected to the nonlinear operation and the other set of the divided data, and a means of combining the divided data (not illustrated).

The generalized-Feistel-type data converting means 10 and the generalized-Feistel-type data converting means 12 are in a relationship of an inversion function with each other.

As illustrated in FIG. 4, the encryption device 1 receives the plain text 40 and the extended key data 41, and outputs the encrypted text 42. The plain text 40 are stirred with the extended key data 41 by the generalized-Feistel-type data converting means 10, and then, are stirred with the extended key data 41 by the Feistel-type data converting means 11, and lastly, are stirred with the extended key data 41 by the generalized-Feistel-type data converting means 12, so that the encrypted text 42 is output. The plain text 40 is equivalent to the transmission data, and the encrypted text 42 is equivalent to the encrypted data.

The generalized-Feistel-type data converting means 10 and the generalized-Feistel-type data converting unit 12 each divide input data into three or more, stir one set or two or more sets of the divided data with the extended key data 41, performs an exclusive OR operation on one set or two or more sets of the remaining data, and repetitively stir the data while crossing the sets of data, to perform conversions.

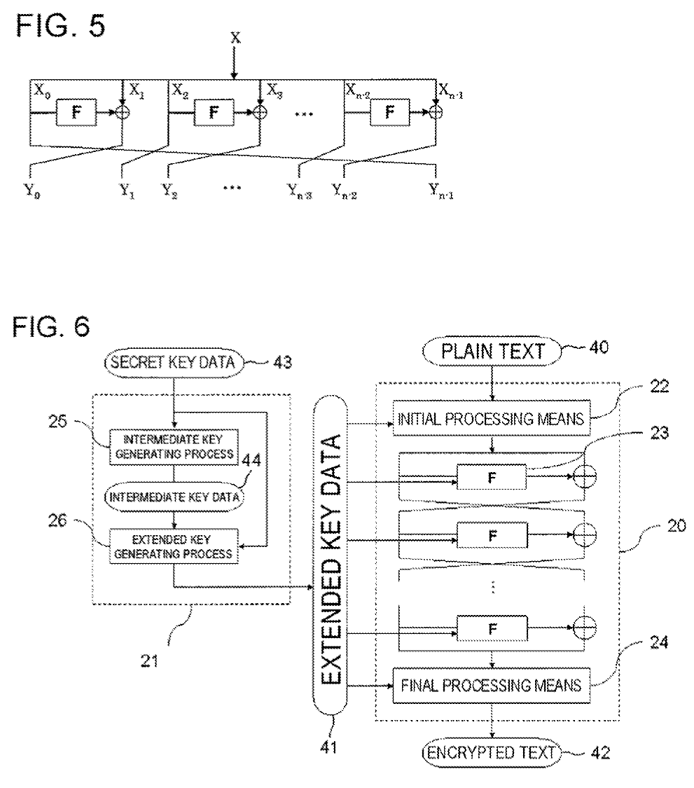

FIG. 5 is a drawing for explaining the encryption processing of the generalized Feistel type. In the encryption processing of the generalized Feistel type, input data X is divided into n sets of data X₀ through Xₙ₋₁. A conversion F is performed on one or more sets of the divided data, and the result of the conversion is applied to another set of data. The processing shifts to the neighboring set, so as to go through the divided data. The conversion F and the round shift are repeated more than once, and the divided data ultimately combined is the output data.

The generalized-Feistel-type data converting units 10 and 12 of this exemplary embodiment use logical OR operations or logical AND operations, but do not use exclusive OR operations, in the stirring of data and the extended key data 41 in the above-described encryption processing of the generalized Feistel type.

Meanwhile, the encryption processing of a Feistel structure is a process in which the number of divisions is two in the regular encryption processing of the generalized Feistel type.

FIG. 6 is a drawing schematically illustrating the structure of the encryption device 20 having the function of the encryption unit 103 of FIG. 1, and the structure of a key schedule device 21 having the function of the key data generating unit 111 of FIG. 1. The encryption device 20 includes an initial processing means 22, an F-function means 23, and a final processing means 24. Referring to FIG. 1, the initial processing means 22 is equivalent to the first converting unit 105, the F-function means 23 is equivalent to the second converting unit 106, and the final processing means 24 is equivalent to the third converting unit 107. Referring to FIG. 4, the initial processing means 22 is equivalent to the generalized-Feistel-type data converting means 10, the F-function means 23 is equivalent to the Feistel-type data converting means 11, and the final processing means 24 is equivalent to the generalized-Feistel-type data converting means 12.

As illustrated in FIG. 6, the encryption device 20 receives the plain text 40 and the extended key data 41, and outputs the encrypted text 42. The plain text 40 are stirred with the extended key data 41 by the initial processing means 22, and are then stirred with the extended key data 41 by the F-function means 23, and lastly, are stirred with the extended key data 41 by the final processing means 24, so that the encrypted text 42 is output.

FIG. 7 is a drawing for explaining an example of the first encryption processing to be performed by the initial processing means 22. As illustrated in FIG. 7, the initial processing means 22 is a generalized Feistel structure that divides input data into four, and performs processing in a two parallel fashion. The initial processing means 22 has the logical AND operation 30 and the logical OR operation 31, and activates the extended key data (ek0 through ek7).

Specifically, input data is divided into four, and the data 701, 702, 703, and 704 are obtained. The data 701 and the extended key data ek0 are subjected to a logical AND operation, and the obtained data and the data 702 are subjected to an exclusive OR operation, to obtain the data 705. After the data 705 and the extended key data ek2 are subjected to a logical OR operation, the obtained data and the data 703 are subjected to an exclusive OR operation, to obtain the data 706. Also, the data 703 and the extended key data ek1 are subjected to a logical OR operation, and the obtained data and the data 704 are subjected to an exclusive OR operation, to obtain the data 707. The data 707 and the extended key data ek3 are subjected to a logical AND operation, and the obtained data and the data 701 are subjected to an exclusive OR operation, to obtain the data 708. The data 708 and the extended key data ek4 are subjected to a logical OR operation, and the obtained data and the data 705 are subjected to an exclusive OR operation, to obtain the data 709. The data 709 and the extended key data ek6 are subjected to a logical AND operation, and the obtained data and the data 706 are subjected to an exclusive OR operation, to obtain the data 710. The data 706 and the extended key data ek5 are subjected to a logical AND operation, and the obtained data and the data 707 are subjected to an exclusive OR operation, to obtain the data 711. The data 711 and the extended key data ek7 are subjected to a logical OR operation, and the obtained data and the data 708 are subjected to an exclusive OR operation, to obtain the data 712. The data 709 through 712 are combined to generate the first converted data.

FIG. 8 is a drawing for explaining another example of the first encryption processing to be performed by the initial processing means 22. Input data is divided into four, and the divided data and the extended key data are sequentially subjected to logical operations.

The differences between the processing illustrated in FIG. 7 and the processing illustrated in FIG. 8 are now described in greater detail. Where hardware implementation is mainly performed, the operation with the data 701 and the operation with the data 703 are independent of each other (do not use the operation result of each other) in the structure illustrated in FIG. 7, and simultaneous processing can be performed. Likewise, the data 705 and the data 707 are independent data, and parallel processing can be performed accordingly. In the structure illustrated in FIG. 8, on the other hand, operations with extended key data are sequentially performed, and therefore, the next operation cannot be started until the previous operation has been ended. Although eight operations with key data are performed in the structure of FIG. 7, two parallel processing can be performed. Accordingly, only four steps are required in the processing. However, the structure of FIG. 8 requires eight steps. Therefore, the structure of FIG. 7 is advantageous, in terms of processing speed.

In the example illustrated in FIG. 8, a processing time twice as long as the processing time required in the example illustrated in FIG. 7. However, the amount of extended key data to be applied to data is larger in the example illustrated in FIG. 8. When a comparison is made at a location having a small amount of extended key data applied thereto, only the four sets of extended key data ek0, ek1, ek2, and ek5 affect the data 32 (711) illustrated in FIG. 7, but five sets of extended key data ek0 through ek4 affect the data 50 illustrated in FIG. 8. In this manner, in the example illustrated in FIG. 7, the larger amount of extended data to affect data can be obtained from the same amount of extended key data.

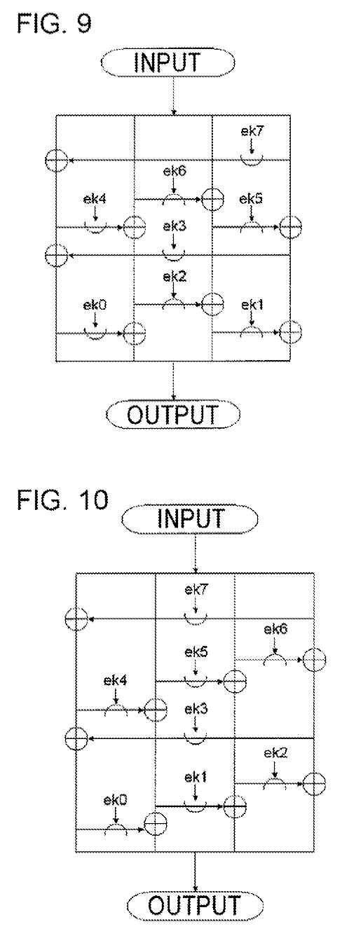

FIG. 9 is a drawing for explaining an example of the second encryption processing to be performed by the final processing means 24. When the initial processing means 22 performs the processing illustrated in FIG. 7, the final processing means 24 performs the processing illustrated in FIG. 9. As illustrated in FIG. 9, the final processing means 24 also has a generalized Feistel structure that divides input data into four and performs processing in a two parallel fashion. The final processing means 24 has the logical AND operation 30 and the logical OR operation 31, and activates the extended key data (ek0 through ek7). The initial processing means 22 and the final processing means 24 are in a relationship of an inverse function with each other, with the process sequence being reversed. Accordingly, the second encryption processing of FIG. 9 to be performed by the final processing means 24 is the inverse function of the first encryption processing to be performed by the initial processing means 22 as illustrated in the example illustrated in FIG. 7.

FIG. 10 is a drawing for explaining another example of the second encryption processing to be performed by the final processing means. When the initial processing means 22 performs the processing illustrated in FIG. 8, the final processing means 24 performs the processing illustrated in FIG. 10. Accordingly, the second encryption processing of FIG. 10 to be performed by the final processing means 24 is the inverse function of the first encryption processing to be performed by the initial processing means 22 as illustrated in the example illustrated in FIG. 8.

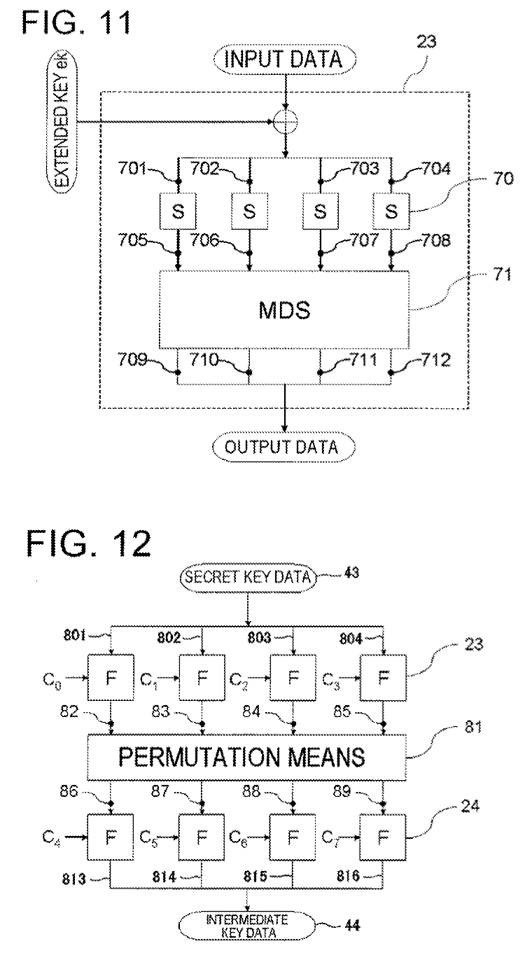

FIG. 11 is a drawing for explaining the encryption processing of the

Feistel structure to be performed by the F-function means 23. As illustrated in FIG. 11, the F-function means 23 includes the processing of extended key data with an exclusive OR operation, a nonlinear converting means 70, and a MDS converting means 71.

The data obtained by performing an exclusive OR operation on input data and extended key data ek is divided into the four sets of data 701 through 704. The data 701 through 704 are respectively converted by the nonlinear converting means 70 (the data 705 through 708). The data 705 through 708 are converted by the MDS converting means 71, and the data 709 through 712 are output. The MDS matrix to be used by the MDS converting means 71 may be the matrix used by MixColumn of AES. Lastly, the data 709 through 712 combined are set as output data.

Referring back to FIG. 6, the key schedule device 21 includes an intermediate key generating means 25 (illustrated as an intermediate key generating process in FIG. 6) and an extended key generating means 26 (illustrated as an extended key generating process in FIG. 6). FIG. 12 is a drawing for explaining the processing to be performed by the key schedule device 21. As illustrated in FIG. 12, the intermediate key generating means 25 includes the F-function means 23 and a permutation means 81. The F-function means 23 is equivalent to the first function processing unit 1006, an F-function means 24 is equivalent to the second function processing unit 1008, and the permutation means 81 is equivalent to the permutation unit 1007.

Secret key data 43 is divided, and is subjected to operations by the F-function means 23. Instead of extended key data, constants (C₀ through C₇) are input to the F-function means 23. The permutation means 81 is a process for permutation data, and one of four divided sets of each set of data 82, 83, 84, and 85 each divided into four is output to data 86. One of four divided sets of each set of the data 82, 83, 84, and 85 each divided into four is also output to the data 87, 88, and 89. However, permutation is performed so that the same data is not output to two or more locations. The F-function means 23 is a process that has each bit of the output affected by all the input bits, and therefore, all the bits of the secret key data 43 affect the intermediate key data 44.

The intermediate key generating means 25 is now described in greater detail. In the following, an example case where the secret key length is 128 bits is described.

The secret key data 43 is divided into four sets of 32-bit data 801 through 804, and each set of data is stirred with the F-function means 23. Instead of the extended key data ek, a constant of zero is given to C₀ through C₃ in the F-function means 23.

The permutation means 81 is a process for permutation data. The data 86 is generated by combining the first bytes of the data 82 through 85, the data 87 is generated by combining the second bytes of the data 82 through 85, the data 88 is generated by combining the third bytes of the data 82 through 85, and the data 89 is generated by combining the fourth bytes of the data 82 through 85. However, the permutation method is not limited to that, if there is no data overlapping.

The data 86 through 89 are again stirred with the F-function means 24. Here, instead of the extended key data ek, hexadecimal constants C₄ through C₇ are used. For example, the following constants are used: C₄=0x6a09bb67, C₅=0x3c6e7311, C₆=0xa54fd413, and C₇=0x298b510e.

Output data 813 through 816 of the F-function means 24 that are combined are used as the intermediate key data 44.

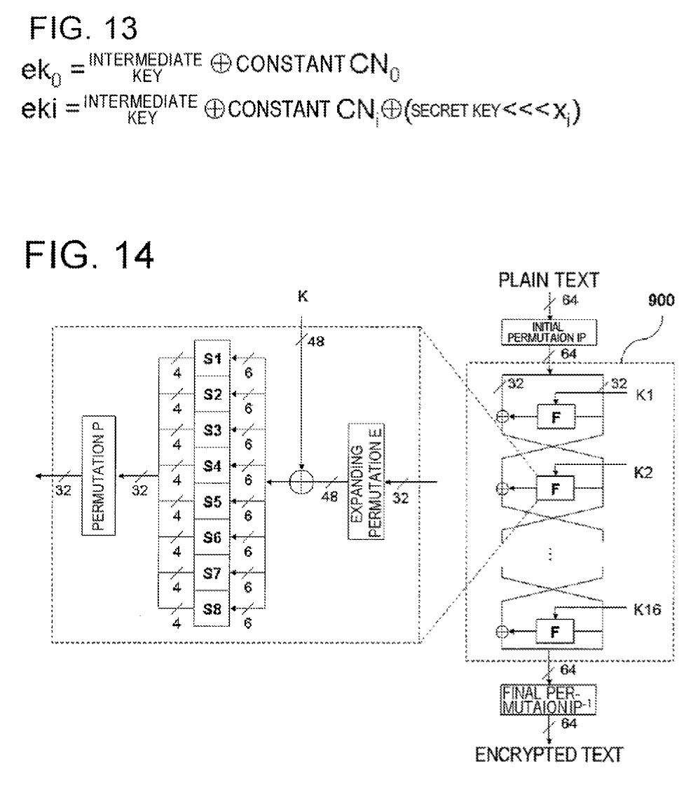

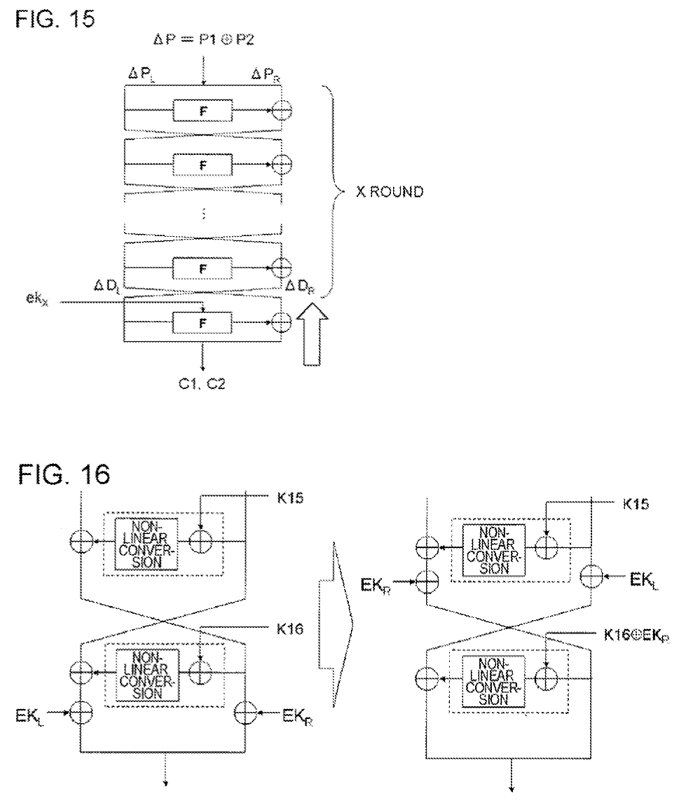

FIG. 13 is a drawing for explaining the processing to be performed by the extended key generating means 26. As illustrated in FIG. 13, the extended key generating means 26 uses extended key data ek0 that is generated by performing an exclusive OR operation on the intermediate key data and a constant. The extended key generating means 26 also generates extended key data ek1 while changing the constant and the number x of round shifts depending on the data amount of required extended key data. The extended key data ek0 is necessary for maintaining the injectivity of the entire extended key data with respect to the secret key data.

Even when the initial processing means 22 and the final processing means 24 use a large amount of extended key data, a large amount of extended key data can be predicted with a small amount of predictions, if extended key data is repeatedly used, or there is a simple relationship among the extended key data. However, by generating the extended key data as described above, the extended key data is not repeatedly used, and a simple relationship is eliminated.

The encryption unit 103 has been described above in detail. However, the decryption unit 203 has the same structure and operations as above, and can obtain decrypted data from reception data.

In this case, the encryption device 20 of FIG. 6 is equivalent to the decryption unit 203, the encrypted text 42 is equivalent to the reception data, and the plain text 40 is equivalent to the decrypted data. When the encryption device 20 functions as the decryption unit 203, the processing progresses in the opposite direction of the direction in which the processing progresses when the encryption device 20 functions as the encryption unit 103. The generalized-Feistel-type data converting unit 12 that receives the reception data stirs the reception data and the extended key data 41. The Feistel-type data converting unit 11 then stirs the obtained data and the extended key data 41. Lastly, the generalized-Feistel-type data converting unit 10 stirs the obtained data and the extended key data 41, to output the decrypted data.

The Feistel structure has a vertically symmetrical shape. Therefore, to perform processing in the reverse direction, the usage sequence of extended keys should be reversed. For example, where the Feistel-type data converting means 11 repeats an F-function in 10 rounds, with the first-round extended key being represented by ek1, the tenth-round extended key being represented by ek10, decryption can be performed by reversing only the extended key data, like ek10 representing the first-round F-function and ek1 representing the tenth-round F-function. In other words, the Feistel structure has the advantage that the structure itself can be shared. Accordingly, even though the generalized-Feistel-type data converting means 10 and the generalized-Feistel-type data converting means 12 having symmetrical structures are added, the symmetric properties are maintained, and the structure itself can be shared between encryption and decryption.

Next, the effects of this exemplary embodiment are described.

According to this exemplary embodiment, in the data converting process of a generalized Feistel type to be performed by the first converting unit 105, a pair of first and second divided transmission data is selected from N, which is three or greater, sets of divided transmission data. A first operation result is generated by performing a logical operation on the first divided transmission data and extended key data, and one set of operation processing data is generated by performing an exclusive OR operation on the second divided transmission data and the first operation result. Also, a second operation result is generated by performing a logical operation on the generated operation processing data and extended key data, and one set of operation processing data is generated by performing an exclusive OR operation on third divided transmission data selected from the divided transmission data and the second operation result. The generated N sets of operation processing data are combined to generate the first converted data. Accordingly, many sets of extended key data can be used, and the resistance to n round elimination attack can be made higher. Since only simple operations are used, this exemplary embodiment has a great advantage in speed performance over an example case where the number of rounds is increased.

Also, according to this exemplary embodiment, the third converting unit 107 performs the second encryption processing, which is in the relationship of an inverse function with the first encryption processing performed by the first converting unit 105, on the second converted data obtained by the second converting unit 106, to obtain encrypted data. Accordingly, since the symmetric properties of the encryption processing of a Feistel structure performed by the second converting unit 106 can be maintained, and the encryption device can also serve as the decryption device. Thus, an increase in size at the time of installation can be restrained.

The n round elimination attack is an attack to estimate the intermediate data obtained after the first round (or the intermediate data of the input in the second round) by predicting extended key data used in the round function of the first round (the F function of DES). When being combined with differential cryptanalysis, a targeted difference can be given to the second round, if the intermediate data after the first round can be estimated. In other words, the n round elimination attack is an attack that regards the second round as the previous first round, and virtually eliminates the first round. Since the predicted extended key data that is shorter than the secret key length is considered to be more efficient than the Brute force attack (an attack to try all the candidates for secret key data), two or more rounds can be eliminated in some structures.

To increase the resistance to the n round elimination attack, the amount of extended key data to be predicted is increased. Where the number of rounds is increased, the amount of extended key data is increased, and the threat becomes smaller. However, the processing becomes slower. In the first converting unit 105 of this exemplary embodiment, the first encryption processing to insert only the extended key data can be performed. Also, in the third converting unit 107, the second encryption processing to insert only the extended key data can be performed. Accordingly, high-speed processing can be performed while the amount of extended key data is being increased.

Meanwhile, when the extended key data is activated only by an exclusive OR operation, movement or coupling of the extended key data is caused, and the amount of extended key data can be actually reduced. According to this exemplary embodiment, however, the first processing unit 1002 and the second processing unit 1003 perform a logical operation on the extended key data and the divided transmission data through a logical OR operation or a logical AND operation. Accordingly, movement and coupling of the key data can be prevented.

In other words, in this exemplary embodiment, the key data is activated by a method other than an exclusive. OR operation in the generalized-Feistel-type processing provided by the first converting unit 105 and the third converting unit 107. Accordingly, movement of the extended key data is prevented, and an increase in resistance to the n round elimination attack can be expected, without a decrease in strength.

Even though the first converting unit 105 and the third converting unit 107 use a large amount of extended key data, a large amount of key data can be predicted with a small amount of predictions, if the extended key data are repeatedly used, and there is a simple relationship among the sets of extended key data. According to this exemplary embodiment, however, the secret key data is divided into M sets, and F-function processing is performed for each set of M-divided key data. The M-divided key data is permutated, and F-function processing can be performed for each set of permutated data. An exclusive OR operation is then performed on the thus generated intermediate key data and a predetermined number, or an exclusive OR operation is performed on the secret key data, the intermediate key data, and the predetermined number. By generating the extended key data in this manner, repeated use of the extended key data and a simple relationship can be eliminated.

As described above, this exemplary embodiment can provide an encryption device that has high security and excellent processing capability. Accordingly, with the data transmission device 100 of this exemplary embodiment, it is possible to provide an encryption method, an encryption device, and an encryption program for shielding data at the time of data communication and storage. More particularly, as for an encryption method utilizing a Feistel structure, it is possible to provide an encryption method, an encryption device, and an encryption program with higher resistance,to n round elimination attack.

Also, this exemplary embodiment can provide a decryption device that has high security and excellent processing capability. With the data reception device 200 of this exemplary embodiment, it is possible to provide a decryption method, a decryption device, and a decryption program for shielding data at the time of data communication and storage. More particularly, as for a decryption method utilizing a Feistel structure, it is possible to provide a decryption method, a decryption device, and a decryption program with higher resistance to n round elimination attack.

Although exemplary embodiments of the present invention have been described with reference to the accompanying drawings, those are merely examples of the invention, and various structures other than the above can be employed.

In this exemplary embodiment, the respective components of the data transmission device and the data reception device can be logically realized as various functions by a computer program. However, each of those components may be formed as unique hardware, or may be realized as a combination of software and hardware.

Although the today's Internet IN is illustrated as the data network in the above exemplary embodiment, the data network may be NGN (Next Generation Network), which is the next-generation Internet.

The above-described exemplary embodiment and modifications may be of course combined, without the contents conflicting with each other. Also, the structures of the respective components have been specifically described in the above exemplary embodiment and modifications, the structures and the like may be modified within the scope of the present invention.

For example, the encryption device 1 of this exemplary embodiment may be an IC module as an encryption processing device that performs encryption processing. The encryption processing of the encryption device 1 can be performed by various information processing devices such as PCs, IC cards, and reader/writers, and an IC module can be formed into any of those various devices.

Although not illustrated in the drawings, the above IC module includes a CPU (Central Processing Unit), a memory, programs, a RAM (Random Access Memory), and the like. The “CPU” is a processor that starts and finishes encryption processing, controls data transmission and reception, controls data transfers among the respective components, and executes other various programs. The “memory” is a ROM (Read-Only-Memory) that stores the programs to be executed by the CPU, and fixed data as operation parameters. The “memory” can be used as the storage area for the extended key data and the like necessary for encryption processing. The storage area for data and the like is preferably designed as a memory having a tamper-proof structure. The “programs” are programs that are executed in the operations of the CPU. The “RAM” is used as a storage area and a work area for the parameters that vary as needed in program operations.

An encrypted IC encryption processing unit performs the encryption processing and the decryption processing of the above-described encryption device 1. The encrypted IC encryption processing unit may have the encryption processing as an individual module, or may not have an independent encryption processing module. For example, the encryption processing program may be stored in the ROM, and the CPU may read and execute the program stored in the ROM.

The above-described IC module includes a random number generator that generates the random numbers required to generate the necessary keys in the encryption processing.

The above-described IC module also includes a data communication processing unit that performs data communications with the outside. The data communication processing unit performs data communications with an IC module such as a reader/writer, outputs encrypted texts generated in the IC module, and receives data from an external device such as a reader/writer.

The series of processing procedures described in the specification can be carried out by hardware, software, or a complex structure of hardware and software. When processing by software is performed, the program that records the process sequence and is installed in a memory incorporated into special-purpose hardware in a computer may be executed, or a program that is installed in a general-purpose computer that can perform various kinds of processing may be executed.

For example, the program can be recorded in advance on a hard disk as a recording medium or a ROM (Read Only Memory). Alternatively, the program can be temporarily or permanently stored (recorded) on a removable recording medium such as a flexible disk, a CD-ROM (Compact Disc Read Only Memory), an MO (Magnet Optical) disk, a DVD (Digital Versatile Disc), a magnetic disk, or a semiconductor memory. Such a removable recording medium can be provided as package software.

The program is installed into a computer from the above-described removable recording medium. Other than that, the program may be wirelessly transferred from a download site to a computer. Alternatively, the program may be transferred by a wire to a computer via a network such as a LAN (Local Area Network) or the Internet, the computer receives the programs transferred in that manner, and the programs are installed in a recording medium such as a built-in hard disk.

For example, the present invention may employ the following structures.

(1) An encryption device that encrypts and decrypts data, with inputs being data and key data,

the encryption device characterized by including a first generalized-Feistel-type data converting unit, a Feistel-type data converting unit, and a second generalized-Feistel-type data converting unit,

the generalized-Feistel-type data converting units including:

a unit which divides input data into three or more;

a unit which performs a logical operation on one or more sets of the divided data and extended key data;

a unit which performs an exclusive OR operation on the data subjected to the logical operation and another set of the divided data; and

a unit which combines the divided data,

the Feistel-type data converting unit including:

a unit which divides input data into two;

a unit which performs a nonlinear operation after applying extended key data to one set of the divided data;

a unit which performs an exclusive OR operation on the data subjected to the nonlinear operation and another set of the divided data; and

a unit which combines the divided data,

the first and second generalized-Feistel-type data converting units being in the relationship of an inverse function with each other.

(2) The encryption device according to (1), wherein the round function in the Feistel processing has a key inserting unit, a nonlinear converting unit, and a MDS transforming unit,

the key inserting unit stirs an input and a key with the use of a linear operation,

the nonlinear transforming unit stirs the output of the key inserting unit with a nonlinear operation, and

the MDS converting unit MDS-converts the output of the nonlinear transforming unit.

(3) The encryption device according to (1) or (2), wherein a key schedule device that generates key data to be used for data encryption includes an intermediate key generating unit and an extended key generating unit,

the intermediate key generating unit is a bijective process in which all the bits of a secret key affect each bit of an intermediate key,

the extended key generating unit is a process to perform an exclusive OR operation on the secret key, the intermediate key, and a constant, or on the intermediate key and the constant, to generate an extended key, and

the extended key always includes a key obtained by performing an exclusive OR operation on all the bits of the intermediate key and the constant.

Further, the present invention can employ the following structures.

(4) A data transmission device including:

a transmission data receiving unit that receives transmission data for network transmission and extended key data;

a first converting unit that performs first operation processing on the transmission data to obtain first converted data;

a second converting unit that performs Feistel-type encryption processing on the first converted data to obtain second converted data;

a third converting unit that performs second operation processing that is in the relationship of an inverse function with the first operation processing on the second converted data, to obtain encrypted data; and

a transmission unit that transmits the encrypted data, the first converting unit including:

a transmission data dividing unit that divides the transmission data into three or more to obtain divided transmission data;

a first processing unit that performs a logical operation on one set of the divided transmission data and the extended key data, to process the divided transmission data;

a second processing unit that performs an exclusive OR operation on one set of the divided transmission data and the divided transmission data processed by the first processing unit, to process the divided transmission data; and

a transmission data combining unit that integrates the processed divided transmission data,

the first operation processing being performed with those units.

(5) The data transmission device according to (4), wherein

the first processing unit performs a logical operation on the divided transmission data processed by the second processing unit and the extended key data.

(6) The data transmission device according to (4) or (5), wherein the second processing unit further performs an exclusive OR operation on the divided transmission data subjected to the exclusive OR operation and the divided transmission data processed by the first processing unit.

(7) The data transmission device according to any one of (4) through (6), characterized in that the logical operation is a logical OR operation or a logical AND operation.

(8) The data transmission device according to any one of (4) through (7), further wherein

a key data generating unit that generates the extended key data from secret key data via intermediate key data,

the key data generating unit including:

a key dividing unit that divides the secret key data into N sets, and obtains N-divided key data;

a first function processing unit that performs F-function processing on each set of the N-divided key data;

a permutation unit that divides the N-divided key data subjected to the F-function processing, and combines part of one set of the N-divided key data and part of another set of the N-divided key data, to permutate the N-divided key data and output N sets of permutated data;

a second function processing unit that performs F-function processing on each set of the output permutated data; and

a key combining unit that integrates the permutated data subjected to the F-function processing, to generate the intermediate key data,

an exclusive OR operation being performed on the intermediate key data and a predetermined number, or an exclusive OR operation being performed on the secret key data, the intermediate key data, and the predetermined number, to generate the extended key data.

(9) A data reception device including:

a reception data receiving unit that receives reception data received via a network and extended key data;

a first converting unit that performs first operation processing on the reception data to obtain first converted data;

a second converting unit that performs Feistel-type decryption processing on the first converted data to obtain second converted data; and

a third converting unit that performs second operation processing that is in the relationship of an inverse function with the first operation processing on the second converted data, to obtain decrypted data,

the first converting unit including:

a reception data dividing unit that divides the received reception data into three or more to obtain divided reception data;

a first processing unit that performs a logical operation on one set of the divided reception data and the extended key data, to process the divided reception data;

a second processing unit that performs an exclusive OR operation on one set of the divided reception data and the divided reception data processed by the first processing unit, to process the divided reception data; and

a reception data combining unit that integrates the processed divided reception data,

the first converting unit performing the first operation processing with the above units.

(10) A data transmission method including:

receiving transmission data for network transmission and extended key data;

obtaining first converted data by performing first operation processing on the transmission data;

obtaining second converted data by performing Feistel-type encryption processing on the first converted data;

obtaining encrypted data by performing second operation processing that is in the relationship of an inverse function with the first operation processing on the second converted data; and

transmitting the encrypted data,

the first operation processing including:

obtaining divided transmission data by dividing the transmission data into three or more;

processing the divided transmission data by performing a logical operation on one set of the divided transmission data and the extended key data;

processing the divided transmission data by performing an exclusive OR operation on one set of the divided transmission data and the divided transmission data processed through the logical operation; and

integrating the processed divided transmission data.

(11) A computer program for causing a data transmission device to perform:

a transmission data receiving process to receive transmission data for network transmission and extended key data;

a first converting process to obtain first converted data by performing first operation processing on the transmission data;

a second converting process to obtain second converted data by performing encryption processing of a Feistel type on the first converted data;

a third converting process to obtain encrypted data by performing second operation processing that is in the relationship of an inverse function with the first operation processing on the second converted data; and

a transmitting process to transmit the encrypted data,

the first operation processing including:

a transmission data dividing process to obtain divided transmission data by dividing the transmission data into three or more;

a first process to process the divided transmission data by performing a logical operation on one set of the divided transmission data and the extended key data;

a second process to process the divided transmission data by performing an exclusive OR operation on one set of the divided transmission data and the divided transmission data processed through the first process; and

a transmission data combining process to integrate the processed divided transmission data.

(12) A data reception method including:

receiving reception data received via a network and extended key data;

obtaining first converted data by performing first operation processing on the reception data;

obtaining second converted data by performing Feistel-type decryption processing on the first converted data; and

obtaining decrypted data by performing second operation processing that is in the relationship of an inverse function with the first operation processing on the second converted data,

the first operation processing including:

obtaining divided reception data by dividing the received reception data into three or more;

processing the divided reception data by performing a logical operation on one set of the divided reception data and the extended key data;

processing the divided reception data by performing an exclusive OR operation on one set of the divided reception data and the divided reception data processed through the logical operation; and

integrating the processed divided reception data.

(13) A computer program for causing a data reception device to perform:

a reception data receiving process to receive reception data received via a network and extended key data;

a first converting process to obtain first converted data by performing first operation processing on the reception data;

a second converting process to obtain second converted data by performing decryption processing of a Feistel type on the first converted data; and

a third converting process to obtain decrypted data by performing second operation processing that is in the relationship of an inverse function with the first operation processing on the second converted data,

the first operation processing including:

a reception data dividing process to obtain divided reception data by dividing the reception data into three or more;

a first process to process the divided data by performing a logical operation on one set of the divided reception data and the extended key data;

a second process to process the divided reception data by performing an exclusive OR operation on one set of the divided reception data and the divided reception data processed through the first process; and a reception data combining process to integrate the processed divided reception data.

(14) A data communication system that connects the data transmission device according to (4) and the data reception device according to (9) via a network.

This application is based on Japanese patent application No. 2008-001844, filed on Jan. 9, 2008, the entire content of which is incorporated hereinto by reference.

Although the present invention has been described so far with reference to an exemplary embodiment, the present invention is not limited to the above embodiment. Various modifications obvious to those skilled in the art within the scope of the invention can be made to the structures and details of the present invention.

1. A data transmission device comprising:
a transmission data receiving unit that receives transmission data;
a first converting unit that performs first encryption processing on said transmission data to generate first converted data;
a second converting unit that performs encryption processing of a Feistel structure on said first converted data to generate second converted data;
a third converting unit that performs second encryption processing that is in a relationship of an inverse function with said first encryption processing on said second converted data, to generate encrypted data; and
a transmission unit that transmits said encrypted data,
said first converting unit including:
a transmission data dividing unit that divides said transmission data into N sets (N being three or greater) of divided transmission data;
an operation unit that performs operation processing on said divided transmission data to generate at least N sets of operation processing data; and
a transmission data combining unit that combines said N sets of operation processing data generated by said operation unit, to generate said first converted data,
said operation unit including:
a first processing unit that selects a pair of first and second divided transmission data from said N sets of divided transmission data, performs a logical operation on said first divided transmission data and extended key data to generate a first operation result, and performs an exclusive OR operation on said second divided transmission data and said first operation result to generate one set of said operation processing data; and
a second processing unit that performs a logical operation on said operation processing data generated by said first processing unit and extended key data to generate a second operation result, and performs an exclusive OR operation on third divided transmission data selected from said N sets of divided transmission data and said second operation result to generate one set of said operation processing data.

2. The data transmission device as claimed in claim 1, wherein the operation unit further includes a third processing unit that selects a pair of said third divided transmission data and fourth divided transmission data from said N sets of divided transmission data, performs a logical operation on said third divided transmission data and extended key data to generate a third operation result, and performs an exclusive OR operation on said fourth divided transmission data and said third operation result to generate one set of said operation processing data.

3. The data transmission device as claimed in claim 1, wherein the operation unit further includes a third processing unit that performs a logical operation on said operation processing data generated by said second processing unit and extended key data to generate a third operation result, and performs an exclusive OR operation on third divided transmission data selected from said N sets of divided transmission data and said third operation result to generate one set of said operation processing data.

4. The data transmission device as claimed in any one of claim 1, wherein
said operation unit uses said generated operation processing data as input data, and performs second operation processing on said N sets of input data to generate N sets of second operation processing data,
said transmission data combining unit combines said N sets of second operation processing data generated by said operation unit, and
said operation unit includes:
a fourth processing unit that selects a pair of first and second input data from said N sets of input data, performs a logical operation on said first input data and extended key data to generate a fourth operation result, and performs an exclusive OR operation on said second input data and said fourth operation result to generate one set of said second operation processing data; and
a fifth processing unit that performs a logical operation on said operation processing data generated by said fourth processing unit and extended key data to generate a fifth operation result, and performs an exclusive OR operation on third input data selected from said N sets of input data and said fifth operation result to generate one set of said second operation processing data.

5. The data transmission device as claimed in claim 4, wherein
said operation unit uses input data that is said N sets of second operation processing data generated through said second operation processing, and repetitively performs said second operation processing on said N sets of input data.)

6. The data transmission device as claimed in claim 1, wherein said logical operation using extended key data is a logical OR operation or a logical AND operation.

7. The data transmission device as claimed in claim 1, further comprising
a key data generating unit that generates extended key data from secret key data via intermediate key data,
said key data generating unit including:
a key dividing unit that divides said secret key data into M (M being two or greater) to generate M-divided key data;
a first function processing unit that performs a round function processing on each set of said M-divided key data;
a permutation unit that divides said M-divided key data subjected to the round function processing, and combines part of one set of said M-divided key data and part of another set of said M-divided key data, to permutate said M-divided key data and output M sets of permutated data;
a second function processing unit that performs round function processing on each set of said output permutated data; and
a key combining unit that combines said permutated data subjected to said round function processing, to generate said intermediate key data,
an exclusive OR operation being performed on said intermediate key data and a predetermined number, or an exclusive OR operation being performed on said secret key data, said intermediate key data, and said predetermined number, to generate said extended key data.

8-11. (canceled)

12. A data transmission method comprising:
acquiring transmission data;
generating first converted data by performing first encryption processing on said transmission data;
generating second converted data by performing encryption processing of a Feistel structure on said first converted data;
generating encrypted data by performing second encryption processing that is in a relationship of an inverse function with said first encryption processing on said second converted data; and
transmitting said encrypted data,
said generating the first converted data including:
dividing said transmission data into N sets (N being three or greater) of divided transmission data;
generating at least N sets of operation processing data by performing operation processing on said divided transmission data; and
generating said first converted data by combining said N sets of operation processing data generated in said generating the N sets of operation processing data,
said generating the N sets of operation processing data including:
performing first processing to select a pair of first and second divided transmission data from said N sets of divided transmission data, generate a first operation result by performing a logical operation on said first divided transmission data and extended key data, and generate one set of said operation processing data by performing an exclusive OR operation on said second divided transmission data and said first operation result; and
performing second processing to generate a second operation result by performing a logical operation on said operation processing data generated in said performing the first processing and extended key data, and generate one set of said operation processing data by performing an exclusive OR operation on third divided transmission data selected from said N sets of divided transmission data and said second operation result.

13. The data transmission method as claimed in claim 12, further comprising
generating said extended key data from secret key data via intermediate key data,
said generating the extended key data including:
generating M-divided key data by dividing said secret key data into M (M being two or greater);
performing round function processing on each set of said M-divided key data;
permutating said M-divided key data and outputting M sets of permutated data by dividing said M-divided key data subjected to said round function processing, and combining part of one set of said M-divided key data and part of another set of said M-divided key data;
performing round function processing on each set of said output permutated data;
generating said intermediate key data by combining said permutated data subjected to said round function processing; and
an exclusive OR operation being performed on said intermediate key data and a predetermined number, or an exclusive OR operation being performed on said secret key data, said intermediate key data, and said predetermined number, to generate said extended key data.

14. A computer readable recording medium recording a program for causing a computer to perform:
a transmission data receiving process to receive transmission data;
a first converting process to generate first converted data by performing first encryption processing on said transmission data;
a second converting process to generate second converted data by performing encryption processing of a Feistel structure on said first converted data;
a third converting process to generate encrypted data by performing second encryption processing that is in a relationship of an inverse function with said first encryption processing on said second converted data; and
a transmitting process to transmit said encrypted data, said first converting process including:
a transmission data dividing process to divide said transmission data into N sets (N being three or greater) of divided transmission data;
an operating process to generate at least N sets of operation processing data from said divided transmission data; and
a transmission data combining process to generate said first converted data by combining said N sets of operation processing data generated through said operation processing,
said operating process including:
a first process to select a pair of first and second divided transmission data from said N sets of divided transmission data, generate a first operation result by performing a logical operation on said first divided transmission data and extended key data, and generate one set of said operation processing data by performing an exclusive OR operation on said second divided transmission data and said first operation result; and
a second process to generate a second operation result by performing a logical operation on said operation processing data generated through said first process and extended key data, and generate one set of said operation processing data by performing an exclusive OR operation on third divided transmission data selected from said N sets of divided transmission data and said second operation result.

15. The recording medium as claimed in claim 14, wherein said program further includes
a key data generating process to generate said extended key data from secret key data via intermediate key data,
said key data generating process includes:
a key dividing process to generate M-divided key data by dividing said secret key data into M (M being two or greater);
a first function process to perform around function processing on each set of said M-divided key data;
a permutation process to permutate said M-divided key data and output M sets of permutated data by dividing said M-divided key data subjected to the round function processing, and combining part of one set of said M-divided key data and part of another set of said M-divided key data;
a second function process to perform round function processing on each set of said output permutated data; and
a key combining process to generate said intermediate key data by combining said permutated data subjected to said round function processing, and
an exclusive OR operation is performed on said intermediate key data and a predetermined number, or an exclusive OR operation is performed on said secret key data, said intermediate key data, and said predetermined number, to generate said extended key data.

16-20. (canceled)
